(19) United States
(12) Patent Application Publication
(10) Pub. No.: US 2008/0111332 A1
(43) Pub. Date: May 15, 2008

(54) Truck

(75) Inventor: Yutaka Nabata, Ksugai-shi (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: NITTO CO., LTD., Kasugai-shi (JP)

(21) Appl. No.: 11/939,043

(22) Filed: Nov. 13, 2007

(30) Foreign Application Priority Data
Nov. 14, 2006 (JP) 2006-307709

(51) Int. Cl. B62B 3/00; B62D 51/04

(52) U.S. Cl. 280/79.11; 180/19.1

(57) ABSTRACT

To provide the truck which is capable of giving easy assembling and disassembling processes. The truck, comprising the load-carrying blocks 20 under which the casters 40 can be fixed and the long connecting frames 30 which can connect the load-carrying blocks 20, the truck 10 is formed as connecting the load-carrying blocks 20 by the connecting frames 30 and casters 40 are fixed under the load-carrying blocks 20 located at corners thereof, further comprising the retainer 25 covering to retain the first side of a fixing plate 43 of the caster 40 and the pawl engagement section 26 engaging the second side of the fixing plate 43, which is opposite to the first side retained by the retainer 25.

### FIELD OF THE INVENTION

This invention relates to a truck which can transport as loading goods or containers, in which goods are stored, thereon.

### BACKGROUND OF THE INVENTION

Conventionally, a known truck for transporting the goods, as shown in the Patent Document 1 and the Patent Document 2, is such that four load-carrying blocks with casters fixed on back surfaces of the casters are connected to a long connecting frame and upper portions of the load-carrying blocks connected in a rectangular form is utilized as the truck. The conventional truck of this type is such that the fixing plate of the caster is fixed on the back surface of the load-carrying block by fasteners such as a bolt and a nut and that the load-carrying block and the connecting frame are fixed by fasteners such as a bolt.

### Patent Document 1

Provisional Japanese Utility Model Publication No. 6-55938. Provisional Japanese Patent Publication No. 2002-2496

However, for the conventional truck, the casters and the connecting frames are fixed on the load-carrying block by the fasteners such as bolts, and therefore assembling the truck or disassembling the truck for disposal requires tools such as a spanner and steps of rotating to fasten or loosen the fasteners such as a screw using the tools, which increases the time of assembling and disassembling processes.

In consideration of the above-problems, an object of the invention in this application is to provide the truck which is capable of giving easy assembling and disassembling processes.

### SUMMARY OF INVENTION

The truck according to this invention comprises load-carrying blocks under which casters can be fixed and long connecting frames which can connect the load-carrying blocks, the truck is formed as connecting the load-carrying blocks by the connecting frames and casters are fixed under the load-carrying blocks located at corners thereof, further comprising a retainer covering to retain a first side of a fixing plate of the caster and a pawl engagement section engaging a second side of the fixing plate, which is opposite to the first side retained by the retainer.

As such, the first side of the fixing plate of the caster is retained by the retainer of the load-carrying block to engagingly fix the second side opposite to the first side, thereby facilitating to fix the caster on the back surface of the load-carrying block, and by releasing the engagement of the fixing plate by means of the pawl engagement section as moving the same, the caster can easily be removed from the load-carrying block, thereby facilitating the assembly and disassembly of the truck.

Also, the retainer of the load-carrying block and the pawl engagement section are designed to fix the fixing plate, and therefore no fasteners such as bolts to fix the caster of the conventional truck, which reduces the number of components of the truck and gives an easy assembly and disassembly without rotating the fasteners by tools such as the spanner.

The truck relating to this invention, in addition to the above structure, comprises load-carrying blocks under which casters can be fixed and long connecting frames which can connect the load-carrying blocks, the truck is formed as connecting the load-carrying blocks by the connecting frames and casters are fixed under the load-carrying blocks located at corners thereof, further comprising a frame support, provided at the load-carrying block, which is arranged at least at two surfaces thereof and supports an end of the connecting frame as inhibiting a movement thereof in an axial right angle direction, a restricting piece, provided at the load-carrying block, which restricts a movement of the connecting frame supported by the frame support in an axial direction, and a fitting groove, provided at the connecting frame, which fits with the restricting piece of the load-carrying block.

Here, a side surface of the load-carrying block, where the frame support is positioned, may be such as “two orthogonal side surfaces”, “two facing side surfaces and one side surface orthogonal to the side surfaces”, and “two facing side surfaces and two side surfaces orthogonal to the side surfaces”. Also, the “frame support” may be such as “a member (in a vent shape) enclosing a periphery of the connecting frame” and “a member (in a pole shape) inserting in the connecting frame in a pipe shape”. Furthermore, the connecting frame functions as long as the frame is extended in a long shape, and the cross sectional peripheral shape may be a circle, triangle, rectangle, hexagon, C-shape, L-shape, and H-shape.

According to this invention, as simply supporting the end of the connecting frame by the frame support of the load-carrying block and fitting the restricting piece of the load-carrying block in the fitting groove of the connecting frame, the connecting frame can be fixed to the load-carrying block, which facilitates the assembling process of the truck. Also, a simple process of releasing the engagement as lifting the restricting piece from the fitting groove allows to remove the connecting frame from the load-carrying block easily, which facilitates the disassembling process of the truck.

The truck of this invention, in addition to the above structure, further comprises a stopper which is fixed to the load-carrying block to restrict a movement of the pawl engagement section.

As such, because the stopper restrict the movement of the pawl engagement section, the movement of the pawl engagement section is inhibited even if a load such as a large lateral force to the caster is applied, and the disengagement of the caster from the load-carrying block due to the pawl engagement section movement can be prevented, thereby increasing the safety of the truck.

As stated above, according to this invention, assembly of components such as the caster and the connecting frame to the load-carrying block of the truck can be performed without any fastener, thereby providing the truck giving easy assembling and disassembling processes.

### BRIEF DESCRIPTION OF THE DRAWINGS

The above and other objects of the present invention will become readily apparent by reference to the following detailed description when considered in conjunction with the accompanying drawings wherein:

FIG. 1 is a perspective view of the truck according to this invention;

FIG. 2(A) is an enlarged plan view of the load-carrying block of the truck; FIG. 2(B) is a bottom view of FIG. 2(A);

FIG. 3(A) is a cross section view taken along the line A-A of FIG. 2; FIG. 3(B) is a cross section view taken along the line B-B of FIG. 2;

FIG. 4 is an enlarged partial exploded view of the load-carrying block;

FIG. 5 is an explanation view of the fixing process of the connecting frame to the load-carrying block; and

FIG. 6 is a perspective view of the truck different from the truck in the embodiments of FIG. 1.

### DESCRIPTION OF THE PREFERRED EMBODIMENTS

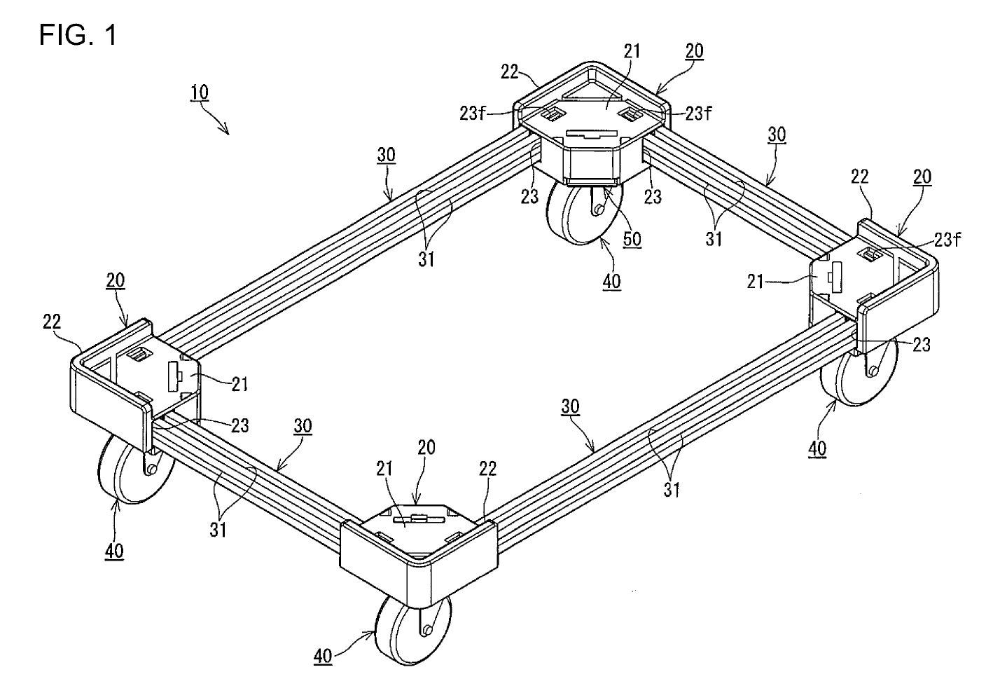

Preferable embodiments of the truck of this invention will be explained in detail with reference to FIGS. 1-5 next. As shown in the figures, a truck 10 of this embodiment is mainly comprised of load-carrying blocks 20, each arranged at four corners of the truck 10, a long connecting frame 30 connecting multiple load-carrying blocks 20, and a caster 40 fixed on a back surface of the load-carrying block 20, and this truck 10 is used for transporting goods and containers storing goods (hereinafter sometimes referred to as goods) as loading the same on four load-carrying block 20 connected with four connecting frame 30. Also, the truck 10 of this example has the caster 40 fixed on the load-carrying block 20 further equipped with a stopper 50 which prevents the disengagement of the caster 40 being disengaged from the load-carrying block 20.

First, the caster 40 used for the truck 10 of this embodiment is comprised of tires 41, which roll on a contacting surface such as a floor surface, tire supports 42 axially rotatably supporting the tires 41, and rectangular fixing plate 43, which retains the tire supports 42 allowing the tire supports 42 to rotate around the axis thereof and has fixing holes 44 at four corners of the fixing plate 43. Therefore, the caster 40 of this example is “adjustable caster”.

Materials and types of the tire 41 of the caster 40 can be selected depending upon conditions and environmental requirements. Also, the structure of the caster 40 is not limited to this example and can be a “fixed caster”. Furthermore, a “stopper caster”, which can restrict the rotation of the tire 41, can be selected as the caster 40.

The load-carrying block 20 is formed in a block shape, whose plan view is pentagon with one angle of the rectangular shape chamfered in C shape and has a certain height, and is mainly comprised of a truck portion 21 loading goods on a surface, a standing wall 22 with a certain width, which raises, to certain degree, from two sides orthogonal to each other with an angle facing a side surface which is formed as chamfered in C shape around an edge of the truck portion 21, the frame support 23 which supports the end of the connecting frame 30, arranged at two side surfaces located to face the standing wall 22, as inhibiting the movement in the axial right angle direction, the restricting piece 24 restricting the movement of the connecting frame supported by the frame support 23 in the axial direction, the retainer 25 covering from below to retain the first side of the fixing plate 43 of the caster 40 arranged on the back surface of the load-carrying block 20, and the pawl engagement section 26 engagingly fixing the second side of the fixing plate 43, which is opposite to the first side retained by the retainer 25.

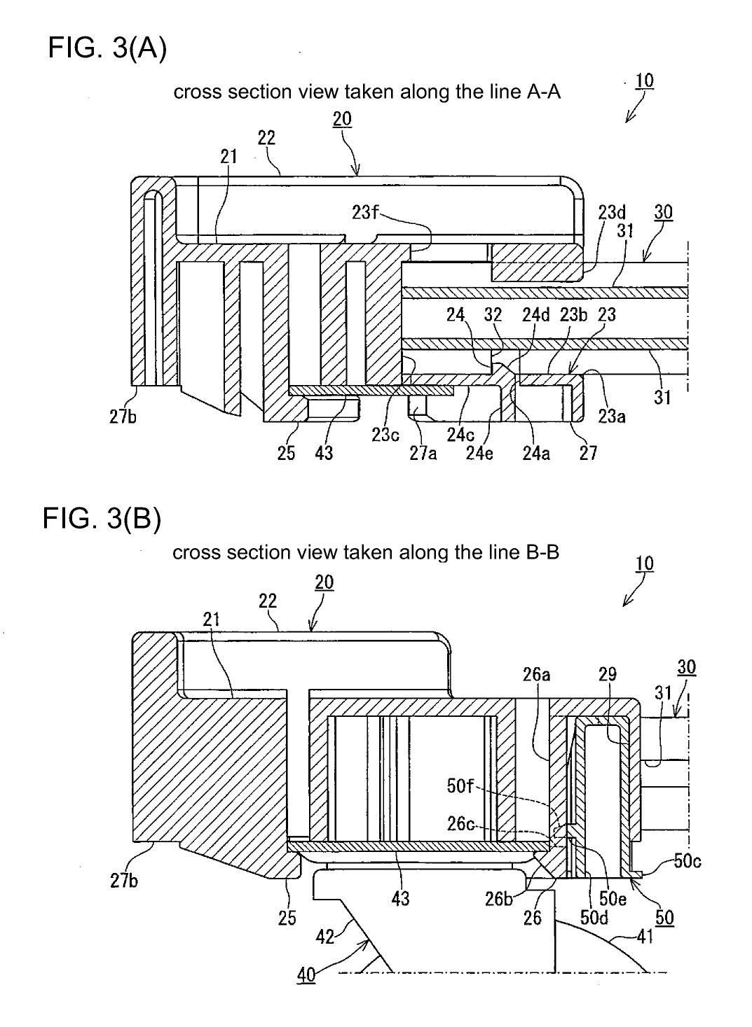

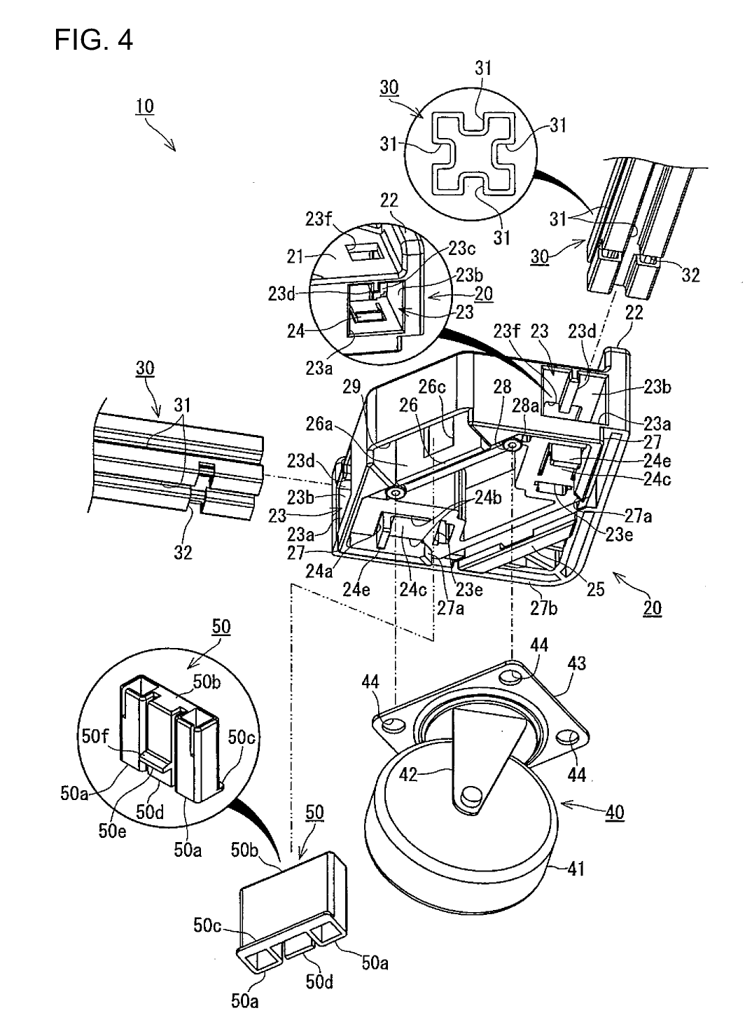

As shown in FIGS. 3(A) and 4, the frame support 23 of the load-carrying block 20 is positioned at two side surfaces orthogonal to each other with the C shaped chamfer there between on the load-carrying block 20 and is comprised of an opening 23a opens at the side surface, an inner cylinder 23b extending, to a certain degree, from the opening 23a in an almost right angle direction relative to the side surface toward inside of the load-carrying block, and a dead end back wall 23c, wherein the inner cylinder 23b, the opening 23a, and the back wall 23c define a not-go bore with a certain depth.

The frame support 23 is designed such that the internal circumferential shape of the opening 23a and the inner cylinder 23b is rectangular with sufficient size for the connecting frame 30 to be inserted in the axial direction thereof, thereby preventing the connecting frame 30 inserted along the inner cylinder 23b from making a relative movement in the axial right angle direction and relative rotation around the axis and restricting the inserted end (i.e., one moving end in the axial direction) of the connecting frame as abutting the end of the connecting frame 30 against the back wall 23c.

Then, as shown in FIGS. 3(A) and 4, the restricting piece 24 is arranged at the inner wall at lower side which forms the inner cylinder 23b around an intermediate portion between the opening 23a and the back wall 23c at the frame support 23 and projects from the inner wall at the lower side of the inner cylinder 23b to the inner cylinder 23b.

A first through groove 24a, which is arranged at the opening 23a of the restricting piece 24 and extending almost parallel to an extending direction of the restricting piece 24 to penetrate the inner wall at the lower side of the inner cylinder 23b, and a second through groove 24b, whose front end arranged at both end sides of the extending direction of the restricting piece 24 is connected with the first through groove 24a while back end extends to the back wall 23c to penetrate through the inner wall at the lower side of the inner cylinder 23b. The first and second through grooves 24a and 24b forms a restricting piece retainer 24c with the restricting piece 24 at the end thereof, and because of an elastic deformation of the restricting piece retainer 24c, the restricting piece 24 elastically moves relative to the surface of the inner wall at the lower side.

Also, as shown in the figures, the restricting piece 24, at the side of the opening 23a at the end side, has a slant surface 24d slops toward the inner wall at the lower side as approaching the end from the projected point around the inner wall at the lower side. In addition, at the restricting piece retainer 24c, there is an operating piece 24e extending downward and toward outside of the load-carrying block 20 at the opposite side to the side where the restricting piece 24 is projected, and the operating piece 24e can be operated to elastically deform the restricting piece retainer 24c easily.

The retainer 25 and the pawl engagement section 26, as shown in the figures, are projecting from the lower surface of the load-carrying block 20 toward the lower portion thereof and are designed to retain the fixing plate 43 to almost match the center of the fixing plate 43 with the center of the load-carrying block 20. Also, the pawl engagement section 26 has a slant surface 26b at the end side (lower end side) sloping away from the retainer 25 as approaching the end. In addition, a plate-like pawl engagement retainer 26a, which has the pawl engagement section 26 has a through hole 26c.

In addition, the load-carrying block 20 of this example has a through hole 23f penetrating the inner wall at the upper side of the inner cylinder 23b at the frame support 23. As shown in FIG. 3(A), an end of the through hole 23f close to the back wall 23c is bent toward the opening 23a more than the back wall 23c, and the connecting frame 30, which is inserted and supported in the inner cylinder 23b of the frame support 23 can be viewed from the outside (upper side) of the load-carrying block 20 through the through hole 23f while the end thereof is being covered.

Furthermore, the load-carrying block 20 has a plate-like leg 27 formed at the lower surface and projecting downward, where the plate-like leg 27 creates a flush side surface with the side surface of the load-carrying block 20 when the frame support 23 is installed therein while the plate-like leg 27 is moved toward the center of the load-carrying block 20 at least to the degree of the width of a standing wall 22 from the side surface thereof when the standing wall 22 is installed. In addition, the leg 27 has a stopper 27a restricting the fixing plate 43 retained by the retainer 25 and the pawl engagement section 26 from moving toward the extension of the retainer 25 and the pawl engagement section 26. Also, the amount of projection of the leg 27 is same as the amount of projection of the retainer 25 and the pawl engagement section 26. The leg 27 has a step portion 27b at the lower surface of the load-carrying block 20 which is fittable with the standing wall 22 projecting from the upper surface of the load-carrying block 20 and allows to stuck the load-carrying blocks 20 on top of each other.

Also, as shown in FIGS. 3(B) and 4, the load-carrying block 20 has a rectangular storing recess 29 with open bottom located between the side surface notched in C shaped chamfer and the pawl engagement section 26, and an inner surface at the side facing the side surface notched in C shaped chamfer of the rectangular storing recess 29 is formed by the plate-like pawl engagement retainer 26a equipped with the pawl engagement section 26. The storing recess 29 is for storing a later described stopper 50. In addition, as shown in the figures, the load-carrying block 20 may have a lightening portion at an appropriate position to reduce the weight.

Also, as shown in FIGS. 3(A) and 4, at both ends of the connecting frame 30, there is a notched fitting groove 32 extending toward a portion predetermined distance away from the ends in the axial right angle direction, and the restricting piece 24 of the load-carrying block 20 fits in the fitting groove 32. Also, as shown in FIG. 1, in the example, two pair of connecting frames 30 with different length are used, thereby connecting four load-carrying blocks 20 with four connecting frames 30 to make the appearance in a plan view of the truck 10 is rectangular.

Furthermore, the connecting frame 30 of this example may be made of metal such as aluminum or stainless steel to form a long member by punching the same in an appropriate length, and the fitting groove 32 is formed by an appropriate processing method. Here, materials such as resin and wood may be used instead of metal.

As the stopper 50 is stored in the storing recess 29 of the load-carrying block 20, the pawl engagement section 26 of the load-carrying block 20 restrict the movement thereof toward the notched side surface in C chamfer and prevent the fixing plate 43 from disengaging from the pawl engagement section 26. As shown in FIG. 4, the stopper 50 as a whole is in an almost rectangular parallelepiped and is comprised of two blocks 50a being in a rectangle shape in cross section and vertically extending upward and downward, a connecting portion 50b being connected so as to make two blocks 50a with predetermined distance to form a continuous surface between the upper end and one side surface, a flange 50c bridging two blocks 50a at one side surface around the bottom of the stopper 50 having the connecting portion 50b therein between and extending outward in the right angle (horizontal) direction, a plate-like movable piece 50d, which is positioned at the side opposite to the flange 50c between two blocks 50a to be fixed its upper end to the connecting portion 50b so as to make almost flush with the other side surface of the block 50a and has a free lower end, and an extended piece 50e extending outward from around lower end of the movable piece 50d in the right angle (horizontal) direction.

As shown in FIG. 3(B), the stopper 50 is designed such that while being stored in the storing recess 29 of the load-carrying block 20, the extended piece 50e is inserted in the through hole 26c formed at the pawl engagement retainer 26a. Also, the stopper 50 can make the extended piece 50e fall in or project from the other side surface of the stopper 50 by elastically deforming the movable piece 50d. Then, the upper surface end of the extended piece 50e has a slant surface 50f.

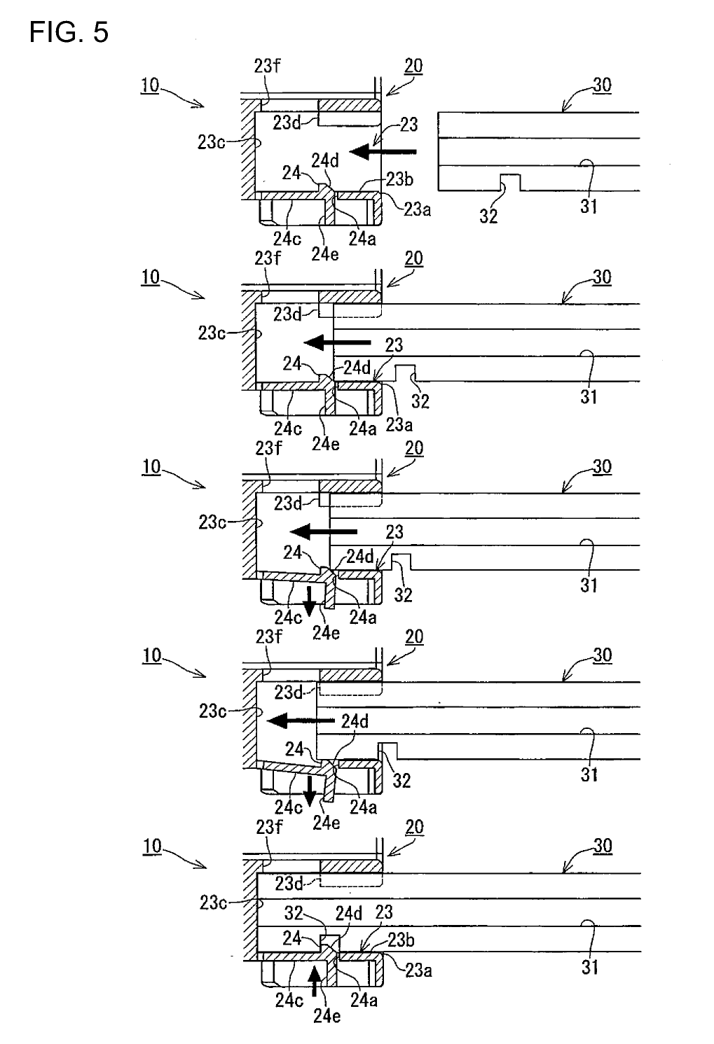

Next, assembling and disassembling processes of the truck 10 of the present embodiment will be explained. When assembling the truck 10, the connecting frame 30 is supported at the frame support 23 of the load-carrying block 20. Concretely, as shown in FIGS. 5, in order to fit the restricting pieces 24 of the frame supports 23 with the fitting groove 32 at the end of the connecting frame 30, the end of the connecting frame 30 is inserted in the inner cylinder 23b from the opening 23a of the frame support 23. The end of the inserted connecting frame 30 abuts against the slant surface 24d of the restricting piece 24 and as the connecting frame 30 is further inserted, the restricting piece retainer 24c is elastically deformed by the movement of the slant surface 24d and once escapes downward as in FIG. 3(A), moving the restricting piece 24 down to the fitting groove 32 at the original position. Then, while fitting with the fitting groove 32 as shown in FIG. 3(A), the movement to disengage from the inside the inner cylinder 23b can be restricted, and the connecting frame 30 is fixed and supported at the frame support 23.

Here, in this example, the frame support 23 of the load-carrying block 20 has the inner cylinder 23b which is in a shape to almost correspond to the peripheral shape of the connecting frame 30; the projecting piece 23d is inserted in the groove 31 of the connecting frame 30; and a convex portion is formed therein to increase the strength of the frame support 23.

Then, in order to direct the truck portions 21 of the load-carrying blocks 20 in the same direction and position the standing wall 22 at the peripheral side, the load-carrying blocks 20 are connected by the connecting frames 30 to assemble in a rectangular frame (condition where the caster 40 is not installed as in FIG. 1). Also, the load-carrying block 20 has the standing wall 22 and the step portion 27b are formed each at the upper side and the lower side, and by superposing the standing wall 22 and the step portion 27b, the truck frames assembled in the frames can be superposed on top of each other without being dislocated.

Then, the caster 40 is fixed on the lower side of each load-carrying block 20. Concretely, one long side of the fixing plate 43 at the caster 40 is retained by inclinedly inserting in the groove retainer 25 at the load-carrying block 20, and the other long side of the fixing plate 43 is moved to the lower surface side of the load-carrying block 20 so that the upper surface of the fixed plate 43 abuts against the lower surface of the load-carrying block 20. At that time, the other long side of the fixing plate 43 abuts against the slant surface 26b at the end of the pawl engagement section 26, so that this movement slides the slant side of the pawl engagement retainer 26a equipped with the pawl engagement section 26 to move rearward. Then, as the entire upper surface of the fixing plate 43 abuts against the lower surface of the load-carrying block 20, the movement due to the slant surface 26b disappears to revive the elastic effect of the pawl engagement retainer 26a, and the other long side of the fixing plate 43 is engaged and fixed by the pawl engagement section 26 (as in FIG. 3(B)).

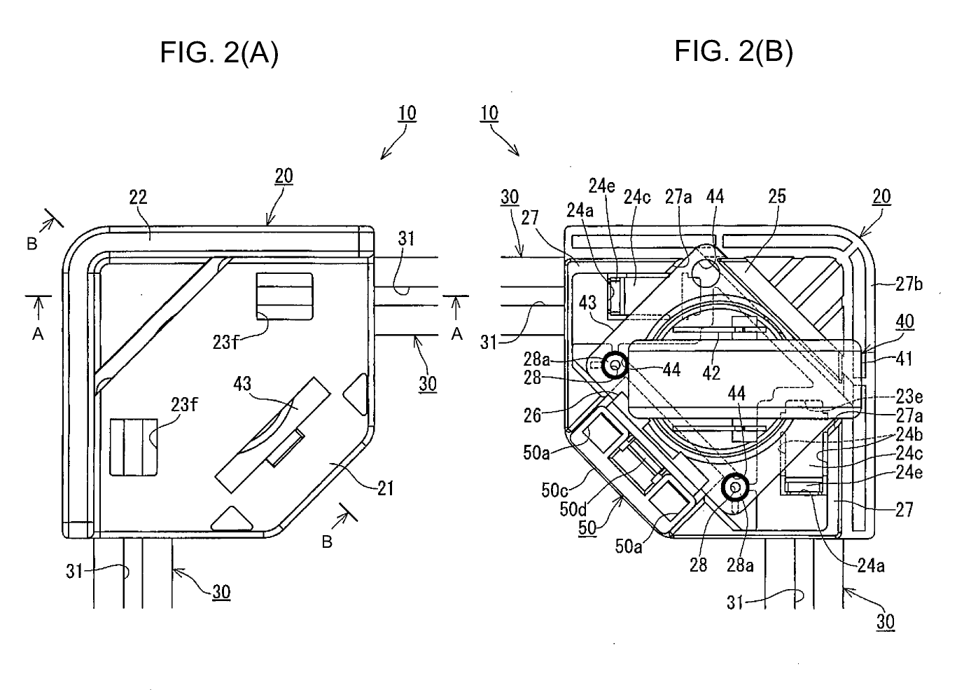

While the fixing plate 43 is being fixed by the retainer 25 and the pawl engagement section 26, as shown in FIG. 2(B), bosses 28a projecting from the lower surface of the load-carrying block 20 are being inserted in two fixing holes 44 arranged at the side where the pawl engagement section 26 is engaged among four fixing holes 44 formed in the fixing plate 43. Also, while being under this condition, the fixing plate 43 is arranged between two stoppers 27a of the leg 27 formed at the lower surface of the load-carrying block 20, and by the boss 28a and the stopper 27a does not make the fixing plate 43 slide along the lower surface of the load-carrying block 20.

While the fixing plate 43 is being fixed by the retainer 25 and the pawl engagement section 26, as shown in FIGS. 2(B) and 3(A), the lower surface of the restricting piece retainer 24c with the restricting piece 24 is covering the upper surface of the fixing plate 43, and the fixing plate 43 prevents the restricting piece retainer 24c from elastically deforming downward, i.e., the direction of disengaging the fitting with the fitting groove 32, thereby preventing the connecting frame 30 from being disengaged from the frame support 23 due to the elastically deformation of the restricting piece retainer 24c for some reasons.

As stated above, after fixing the fixing plate 43 of the caster 40 to the lower surface of the load-carrying block 20, the stopper 50 is inserted in the storing recess 29 of the load-carrying block 20. Concretely, the extended piece 50e of the stopper 50 is directed toward the side of the pawl engagement retainer 26a, and the side opposite to the flange 50c (upper side) becomes an insertion end to be inserted in the storing recess 29 to. As the stopper 50 is inserted in the storing recess 29, the slant surface 50f of the end of the extended piece 50e abuts against the end of the pawl engagement section 26, and the movable piece 50d is elastically deformed due to the movement of the slant surface 50f to fall the extended piece 50e in the stopper 50. When the stopper 50 is further inserted, the movement of the slat surface 50f is removed and the elastic effect is revived in the movable piece 50d, and the extended piece 50e projects in the through hole 26c of the pawl engagement retainer 26a as shown in FIG. 3(B).

Under this condition, the extended piece 50e prevents the stopper 50 from being disengaged from the storing recess 29, and the block 50a of the stopper 50 prevents the pawl engagement retainer 26a from moving toward the C shaped chamber notched side surface and prevents the engagement of the fixing plate 43 from being disengaged as elastically deformed.

Then, the truck 10 assembly is completed as the stoppers 50 are installed to all load-carrying blocks 20 with the fixed casters 40. Also, depending upon the conditions and using environment of the truck 10, a predetermined screw may be inserted in a screw hole 28 of the boss 28a to strengthen the connection of the fixing plate 43 of the caster 40 with the load-carrying block 20.

Next, when disassembling the truck 10, relative to the stopper 50 inserted in the storing recess 29 of the load-carrying block 20, the movable piece 50d is elastically deformed to fall the extended piece 50e in the stopper 50, and the stopper 50 under this condition is removed from the storing recess 29. Then, the pawl engagement retainer 26a is elastically deformed toward the C shaped chamfer notched side surface to remove the engagement of the fixing plate 43 by the pawl engagement section 26, and the fixing plate 43 is pulled out from the retainer 25 to remove the fixing plate 43, i.e., the caster 40 from the load-carrying block 20. After the above step, the operating piece 24e projecting downward from the restricting piece retainer 24c is operated to remove the restricting piece 24 from the fitting groove 32 of the connecting frame 30 as elastically downward deforming the restricting piece retainer 24c, and under this condition, the connecting frame 30 is pulled from the frame support 23 to disassemble the load-carrying block 20 and the connecting frame 30, and the truck 10 can be disassembled into the load-carrying block 20, the connecting frame 30, the caster 40, and the stopper 50.

Here, when pulling of the connecting frame 30 from the frame support 23 is difficult, wedge tools such as a driver can be inserted in a disengagement hole 23e opening at the lower surface of the load-carrying block 20 to facilitate the pulling.

As such, according to the truck 10 of this embodiment, the first side of the fixing plate 43 of the caster 40 is retained by the retainer 25 to engagingly fix the second side opposite to the first side, thereby facilitating to fix the caster 40 on the back surface of the load-carrying block, 20 and by releasing the engagement of the fixing plate 43 by means of the pawl engagement section 26 as moving the same, the caster 40 can easily be removed from the load-carrying block 20, thereby facilitating the assembly and disassembly of the truck 10. In addition, at the same time, the fixing hole 44 of the fixing plate 43 fits with the boss 28a, thereby preventing the load possibly transmitted to the pawl engagement section 26.

Also, no fasteners such as bolts to fix the caster 40 of the conventional truck, which reduces the number of components of the truck and gives an easy assembly and disassembly without rotating the fasteners by tools such as the spanner.

Furthermore, the slant surface 24d is positioned at the end of the restricting piece 24, and therefore when the connecting frame 30 is supported at the frame support 23, the end of the connecting frame 30 abuts against the slant surface 24d to move the restricting piece 24 due to the movement of the slant surface 24d and to support the frame support 23 with the connecting frame 30 without interruption of the restricting piece 24, and when the restricting piece 24 reaches the fitting groove 32, the restricting piece 24 automatically fits in the fitting groove 32 to fix the connecting frame 30, thereby fixing the connecting frame 30 with the load-carrying block 20 with one touch process. Also, a simple process of releasing the engagement as moving the restricting piece 24 from the fitting groove 32 allows to remove the connecting frame 30 from the load-carrying block 20 easily, which facilitates the disassembling process of the truck 10.

Also, this invention also has the stopper 50 for restricting the movement of the pawl engagement section 26, because the stopper 50 restricts the movement of the pawl engagement section 26, the movement of the pawl engagement section 26 is inhibited even if a load such as a large lateral force in the lateral direction to the caster 40 is applied, and the disengagement of the caster 40 from the load-carrying block 20 due to the pawl engagement section movement can be prevented, thereby increasing the safety of the truck 10.

Preferred embodiments of this invention were explained above; however, this invention is not limited to these embodiments, and as described below, any improvement or design modification, without departing from the spirit of this invention, is possible.

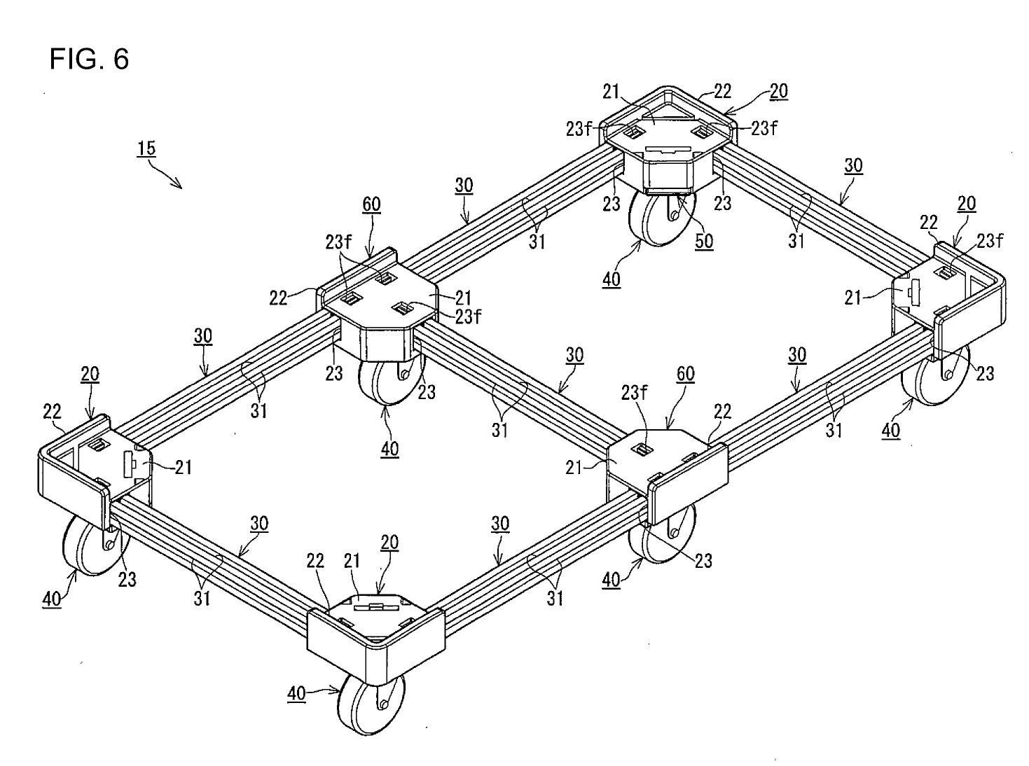

That is, in the above-embodiments, the load-carrying block 20 of the truck 10 is positioned at the corner of the truck 10; however, the load-carrying block 20 is not limited to what is described above and for example as shown in FIG. 6 the load-carrying block 60 may be used. Because the load-carrying block 60 of the truck 15 can be used at the intermediate portion of the truck 10, there are three frame supports 23, and other than two orthogonal side surfaces, the frame support 23 is positioned at one side surface at the opposite side where the frame support 23 is provided. Furthermore, other parts can be same as in the above-described embodiments, where the same reference numbers should applied, and the explanation of which will be omitted. According to the load-carrying block 20, location other than the corners of the truck 15 gives the same effect as the previously described truck 10, thereby supporting such as goods by the casters 40. Then, although it is omitted in the figures, other than what was described above, the frame support 23 may be provided at the side surface of four corners of the load-carrying block 20, 60. In addition, the connecting frame 30 used in this situation can be divided into two or one connecting frame can penetrates the load-carrying block 60.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

### Explanation of Reference Numbers

10, 15 Truck

20, 60 Load-Carrying Block

21 Truck portion

23 Frame Support

24 Restricting Piece

25 Retainer

26 Pawl Engagement Section

30 Connecting Frame

32 Fitting Groove

40 Caster

43 Fixing Plate

50 Stopper

What is claimed is:

1. A truck, comprising load-carrying blocks under which casters can be fixed and long connecting frames which can connect said load-carrying blocks, said truck is formed as connecting the load-carrying blocks by the connecting frames and casters are fixed under the load-carrying blocks located at corners thereof, further comprising a retainer covering to retain a first side of a fixing plate of the caster and a pawl engagement section engaging a second side of the fixing plate, which is opposite to the first side retained by the retainer.

2. A truck, truck, comprising load-carrying blocks under which casters can be fixed and long connecting frames which can connect said load-carrying blocks, said truck is formed as connecting the load-carrying blocks by the connecting frames and casters are fixed under the load-carrying blocks located at corners thereof, further comprising a frame support, provided at the load-carrying block, which is arranged at least at two surfaces thereof and supports an end of the connecting frame as inhibiting a movement thereof in an axial right angle direction, a restricting piece, provided at the load-carrying block, which restricts a movement of the connecting frame supported by the frame support in an axial direction, and a fitting groove, provided at the connecting frame, which fits with the restricting piece of the load-carrying block.

3. The truck according to claim 1, further comprising a stopper which is fixed to the load-carrying block to restrict a movement of the pawl engagement.
